(19) United States
(12) Patent Application Publication
(10) Pub. No.: US 2018/0205325 A1
(43) Pub. Date: Jul. 19, 2018

(54) EMERGENCY POWER SYSTEM AND BOTTOM BLOWING FURNACE EQUIPMENT HAVING THE SAME

(71) Applicant: CHINA ENFI ENGINEERING CORPORATION, Beijing (CN)

(72) Inventors: Hailin BIAN, Beijing (CN); Xiaoman XU, Beijing (CN)

(21) Appl. No.: 15/408,501

(22) Filed: Jan. 18, 2017

(51) Int. Cl. H02M 7/44; H02J 7/00; G08B 21/18; F27D 21/00; F27D 21/04

(52) U.S. Cl. CPC H02M 7/44; H02J 7/0057; F27D 21/04; F27D 21/00; G08B 21/185

(57) ABSTRACT

The present disclosure provides an emergency power system for a bottom blowing furnace and a bottom blowing furnace equipment. The emergency power system includes a battery and a drive controller. The drive controller has a frequency converter and a controller. The frequency converter is configured to convert a direct current input from a DC input interface or an alternating current input from an AC input interface into a variable-frequency alternating current, and to output the variable-frequency alternating current via an AC output interface for providing an emergency power supply to a load of the bottom blowing furnace and controlling a speed of the load. When the city power grid is cut off, the controller controls the frequency converter to switch to the DC input interface, such that the battery inputs the direct current to the frequency converter and the frequency converter converts the direct current to the variable-frequency alternating current.

### FIELD

The present disclosure relates to a metallurgy field, and particularly relates to an emergency power system for a bottom blowing furnace and a bottom blowing furnace equipment.

### BACKGROUND

At present, a main drive motor of a bottom blowing furnace adopts an EPS (Emergency Power System) system as an emergency power supply. When the city power grid is cut off, the EPS system can convert the direct current in the battery into an alternating current by using an inverter, and provide emergency power for loads related to the bottom blowing furnace. Since the existing EPS product provides emergency power for loads as an independent power supply, it cannot participate in the external control, and thus cannot control the speed of the main drive motor of the bottom blowing furnace in real time. Another control device is needed to meet the drive and control requirements of the bottom blowing furnace, and thus the cost is rather high.

### SUMMARY

The present disclosure aims to solve at least one of the existing problems.

For this, the present disclosure provides an emergency power system for a bottom blowing furnace and a bottom blowing furnace equipment.

According to embodiments of a first aspect of the present disclosure, an emergency power system for a bottom blowing furnace is provided. The emergency power system includes a battery, a charging device and a drive control device. The drive control device has a DC input interface connected with the battery, an AC input interface connected with a city power grid and an AC output interface connected with a load of the bottom blowing furnace. The drive control device includes a frequency converter and a controller. The frequency converter is configured to convert a direct current input from the DC input interface or an alternating current input from the AC input interface into a variable-frequency alternating current, and to output the variable-frequency alternating current via the AC output interface, for providing emergency power supply to the load and controlling a speed of the load. The controller is connected to the frequency converter, and configured to control the frequency converter to switch between the DC input interface and the AC input interface. When the city power grid is cut off, the controller controls the frequency converter to switch to the DC input interface, such that the battery inputs the direct current to the frequency converter via the DC input interface and the frequency converter converts the direct current into the variable-frequency alternating current.

The emergency power system of the present disclosure, on one hand, can provide emergency power for the bottom blowing furnace, and on the other hand, can control a speed of a main drive motor of the bottom blowing furnace. Moreover, the emergency power system of the present disclosure has advantages of simple structure and low cost.

In an embodiment, the emergency power system further includes a battery detector. The battery detector is configured to detect a remaining electric quantity of the battery, and the charging device is configured to charge the battery when the remaining electric quantity of the battery is less than a preset electric quantity threshold.

In an embodiment, the emergency power system further includes an alarm device. The alarm device is connected to the controller and the AC input interface respectively, and is configured to output an alarm reminding when the battery is low and/or the city power grid is cut off.

In an embodiment, the alarm device includes an audible alarm and/or a light alarm.

In an embodiment, the frequency converter further includes a control switch configured to switch between the city power grid and the battery.

In an embodiment, the control switch includes a hand control switch.

In an embodiment, the control switch includes a contactor controlled by the controller.

According to embodiments of a second aspect of the present disclosure, a bottom blowing furnace equipment is provided. The bottom blowing furnace equipment includes a bottom blowing furnace and the emergency power system described according to embodiments of the first aspect of the present disclosure.

Additional aspects and advantages of the present disclosure will be given in part in the following descriptions, become apparent in part from the following descriptions, or be learned from the practice of the present disclosure.

### BRIEF DESCRIPTION OF THE DRAWINGS

These and other aspects and advantages of the disclosure will become apparent and more readily appreciated from the following descriptions taken in conjunction with the drawings in which:

FIG. 1 is a block diagram of an emergency power system for a bottom blowing furnace according to an embodiment of the present disclosure.

FIG. 2 is a block diagram of an emergency power system for a bottom blowing furnace according to an embodiment of the present disclosure.

FIG. 3 is block diagram of a bottom blowing furnace equipment according to an embodiment of the present disclosure.

### DETAILED DESCRIPTION

Embodiments of the present disclosure will be described in detail in the following descriptions, examples of which are shown in the accompanying drawings, in which the same or similar elements and elements having same or similar functions are denoted by like reference numerals throughout the descriptions. The embodiments described herein with reference to the accompanying drawings are explanatory and illustrative, which are used to generally understand the present disclosure. The embodiments shall not be construed to limit the present disclosure.

It is to be understood that phraseology and terminology used herein with reference to device or element orientation (such as, terms like “center”, “up”, “down”, “front”, “rear”, “left”, “right”, “top”, “bottom”, “inside”, “outside”) are only used to simplify description of the present invention, and do not indicate or imply that the device or element referred to must have or operated in a particular orientation. They cannot be seen as limits to the present disclosure. Moreover, terms of “first” and “second” are only used for description and cannot be seen as indicating or implying relative importance.

It is to be explained that terms of “installation”, “linkage” and “connection” shall be understood broadly, for example, it could be permanent connection, removable connection or integral connection; it could be direct linkage, indirect linkage or inside linkage within two elements. Those skilled in the art shall understand the concrete notations of the terms mentioned above according to specific circumstances.

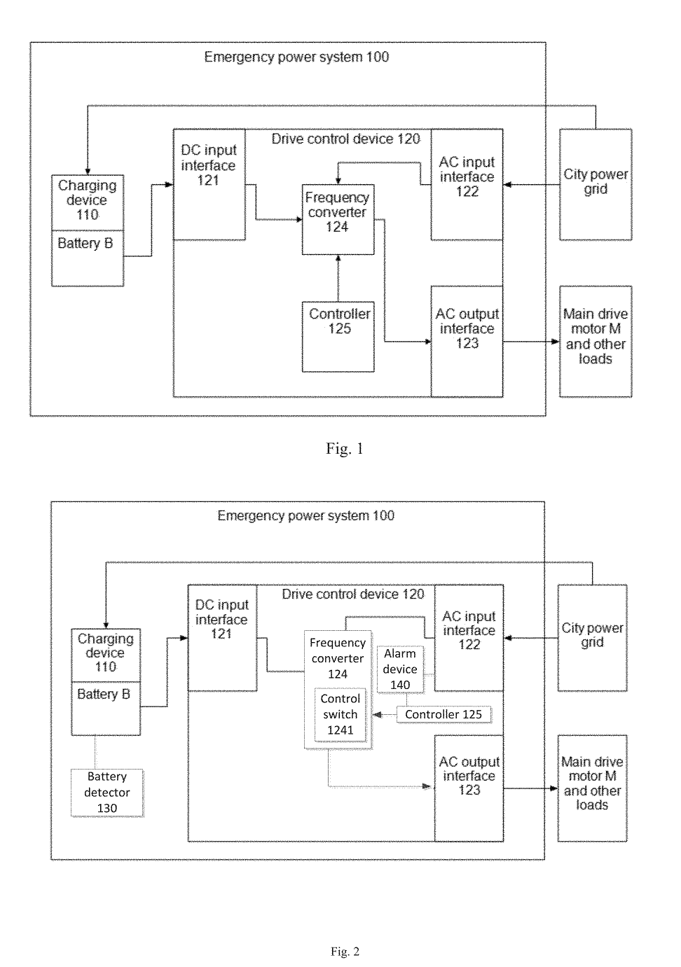

In the following, an emergency power system for a bottom blowing furnace and a bottom blowing furnace equipment according to an embodiment of the present disclosure will be described in detail with reference to FIGS. 1-2.

FIG. 1 is a block diagram of an emergency power system for a bottom blowing furnace according to an embodiment of the present disclosure. As shown in FIG. 1, the emergency power system 100 according to an embodiment of the present disclosure includes a battery B, a charging device 110 and a drive control device 120.

The drive control device 120 has a DC input interface 121, an AC input interface 122 and an AC output interface 123. The DC input interface 121 is connected to the battery B, the AC input interface 122 is connected to the city power grid, and the AC output interface 123 is connected to a load of the bottom blowing furnace, such as the main drive motor M and other loads. The drive control device 120 includes a frequency converter 124 and a controller 125.

The frequency converter 124 is configured to convert a direct current input from the DC input interface 121 or an alternating current input from the AC input interface 122 into a variable-frequency alternating current (a frequency of the alternating current is variable), and to output the variable-frequency alternating current via the AC output interface 123 for providing emergency power supply to the load and controlling a speed of the load. The controller 125 is connected to the frequency converter 124, and is configured to control the frequency converter 124 to switch between the DC input interface 121 and the AC input interface 122. When the city power grid is cut off, the controller 125 controls the frequency converter 124 to switch to the DC input interface 121, such that the battery B inputs the direct current to the frequency converter 124 via the DC input interface 121, and the frequency converter 124 converts the direct current into the variable-frequency alternating current. Then, the emergency power supply and speed control is provided to the load via the AC output interface 123.

The emergency power system for the bottom blowing furnace of the present disclosure, on one hand, can provide emergency power for the bottom blowing furnace, and on the other hand, can control a speed of a main drive motor of the bottom blowing furnace. Moreover, the emergency power system of the present disclosure has advantages of simple structure and low cost.

In an embodiment of the present disclosure, as shown in FIG. 2, the emergency power system 100 further includes a battery detector 130. The battery detector 130 is configured to detect a remaining electric quantity of the battery B, and the charging device 110 is configured to charge the battery B when the remaining electric quantity of the battery B is less than a preset electric quantity threshold. Thus, the battery B can be charged conveniently, thus ensuring a continuous working of the emergency power system and providing convenience for the user.

In an embodiment of the present disclosure, as shown in FIG. 2, the emergency power system 100 further includes an alarm device 140. The alarm device 140 is connected to the controller 125 and AC input interface 122 respectively, and is configured to output an alarm reminding when the battery B is low and/or the city power grid is cut off. Thereby, the user can know the conditions of the bottom blowing furnace in time, and can take immediate measures to ensure the normal operation of the bottom blowing furnace.

In an embodiment of the present disclosure, the alarm device 140 includes but is not limited to an audible alarm and/or a light alarm. The audible alarm and/or the light alarm include but not limited to a loudspeaker and/or a flasher. Thus, the prompt effect can be enhanced effectively, and the user experience of the emergency power system of the bottom blowing furnace can be improved.

In an embodiment of the present disclosure, shown in FIG. 2, the frequency converter 124 also includes a control switch 1241. The control switch 1241 is used for switching between the city power grid and the battery B.

For example, the control switch 1241 is a hand control switch which can be switched by users manually. For instance, the hand control switch can be switched into the city power grid when the city power grid is available. Thus, it is convenient for users to choose the city power grid or the battery B as the power supply for the emergency power system of the bottom blowing furnace, thereby promoting the flexibility of the emergency power system with higher versatility.

As another example, the control switch 1241 is a contactor controlled by the controller 125. In this way, when the city power grid is cut off, the controller 125 can control switching to the battery for power supply timely and automatically. On the contrary, when the city power grid is available, the controller 125 can control switching to the city power grid for power supply timely and automatically. Thus, it can promote the automation level of the system and reduce the manual operation with higher reliability and security.

The emergency power system of the bottom blowing furnace according to embodiments of the present disclosure makes use of characteristics of the frequency converter (i.e., having functions of both speed control and inverting), and replaces the inverter for AC/DC inversion in the existing EPS system with the frequency converter, which can serve as the inverter and the frequency inverting and speed regulating device of the load (such as the main drive motor of the bottom blowing furnace) at the same time. One device now can perform the functions of original two devices, which can avoid the repeated configuration and realize the integration of device. In addition, the inverter in the related art has only one DC input interface, such that in the existing EPS system, it needs to invert the DC in battery into AC by the inverter firstly, and then power supply can be provided to the load after the ATSE (Automatic Transfer Switching Equipment) and switching to the city power grid. However, in the emergency power system according to embodiments of the present disclosure, the inverter is replaced with the frequency converter, such that both the city power grid and DC of the battery can access to the frequency converter, thereby reducing switching actions of the ATSE. In addition, the controller is integrated into the emergency power system, and thus the external control instruction can access into the frequency converter inside the emergency power system via the controller.

Embodiments of the present disclosure also provide a bottom blowing furnace equipment.

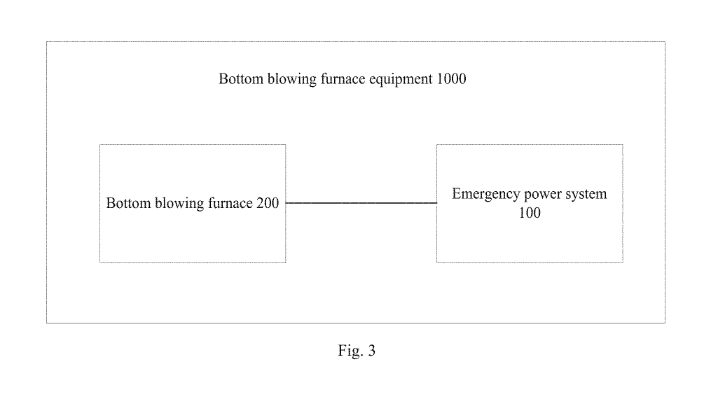

FIG. 3 is a block diagram of a bottom blowing furnace equipment according to an embodiment of the present disclosure. As shown in FIG. 3, the bottom blowing furnace equipment 1000 includes a bottom blowing furnace 200 and an emergency power system 100. The emergency power system 100 is connected with the bottom blowing furnace 200 and configured to provide emergency power supply to a load of the bottom blowing furnace 200 and to control a speed of the load.

With respect to the emergency power system, reference may be made to the above description, which will not be elaborated herein.

In addition, other components and effects of the bottom blowing furnace equipment according to embodiments of the present disclosure are known to those skilled in the art, and thus are not elaborated herein for clarity.

Reference throughout this specification to “an embodiment”, “some embodiments”, “one schematic embodiment”, “an example”, “a specific example”, or “some examples” means that a particular feature, structure, material, or characteristic described in connection with the embodiment or example is included in at least one embodiment or example of the disclosure. Thus, the appearances of the phrases such as “in some embodiments”, “in one embodiment”, “in an embodiment”, “an example”, “a specific example”, or “some examples” in various places throughout this specification are not necessarily referring to the same embodiment or example of the disclosure. Furthermore, the particular features, structures, materials, or characteristics may be combined in any suitable manner in one or more embodiments or examples.

Although explanatory embodiments have been shown and described, it would be appreciated by those skilled in the art that changes, alternatives, and modifications may be made in the embodiments without departing from spirit and principles of the disclosure. Such changes, alternatives, and modifications all fall into the scope of the claims and their equivalents.

1. An emergency power system for a bottom blowing furnace, comprising:
a battery;
a charging device, configured to charge the battery;
a drive control device, having a DC input interface connected with the battery, an AC input interface connected with a city power grid and an AC output interface connected with a load of the bottom blowing furnace, and comprising:
a frequency converter, configured to convert a direct current input from the DC input interface or an alternating current input from the AC input interface into a variable-frequency alternating current, and to output the variable-frequency alternating current via the AC output interface for providing emergency power supply to the load and controlling a speed of the load; and
a controller, connected to the frequency converter, and configured to control the frequency converter to switch between the DC input interface and the AC input interface,
wherein, when the city power grid is cut off, the controller controls the frequency converter to switch to the DC input interface, such that the battery inputs the direct current to the frequency converter via the DC input interface and the frequency converter converts the direct current into the variable-frequency alternating current.

2. The emergency power system according to claim 1, further comprising:
a battery detector, configured to detect a remaining electric quantity of the battery;
wherein the charging device is configured to charge the battery when the remaining electric quantity of the battery is less than a preset electric quantity threshold.

3. The emergency power system according to claim 1, further comprising:
an alarm device, connected to the controller and the AC input interface respectively, and configured to output an alarm reminding when the battery is low and/or the city power grid is cut off.

4. The emergency power system according to claim 3, wherein the alarm device comprises an audible alarm and/or a light alarm.

5. The emergency power system according to claim 1, wherein the frequency converter further comprises a control switch configured to switch between the city power grid and the battery.

6. The emergency power system according to claim 5, wherein the control switch comprises a hand control switch.

7. The emergency power system according to claim 5, wherein the control switch comprises a contactor controlled by the controller.

8. A bottom blowing furnace equipment, comprising:
a bottom blowing furnace;
an emergency power system, connected to the bottom blowing furnace, and comprising:
a battery;
a charging device, configured to charge the battery;
a drive control device, having a DC input interface connected with the battery, an AC input interface connected with a city power grid and an AC output interface connected with a load of the bottom blowing furnace, and comprising:
a frequency converter, configured to convert a direct current input from the DC input interface or an alternating current input from the AC input interface into a variable-frequency alternating current, and to output the variable-frequency alternating current via the AC output interface for providing emergency power supply to the load and controlling a speed of the load; and
a controller, connected to the frequency converter, and configured to control the frequency converter to switch between the DC input interface and the AC input interface,
wherein, when the city power grid is cut off, the controller controls the frequency converter to switch to the DC input interface such that the battery inputs the direct current to the frequency converter, and controls the frequency converter to convert the direct current into the variable-frequency alternating current.

9. The bottom blowing furnace equipment according to claim 8, wherein the emergency power system further comprises:
a battery detector, configured to detect a remaining electric quantity of the battery;
wherein the charging device is configured to charge the battery when the remaining electric quantity of the battery is less than a preset electric quantity threshold.

10. The bottom blowing furnace equipment according to claim 8, wherein the emergency power system further comprises:
an alarm device, connected to the controller and the AC input interface respectively, and configured for alarm reminding when the battery is low and/or the city power grid is cut off.

11. The bottom blowing furnace equipment according to claim 10, wherein the alarm device comprises an audible alarm and/or a light alarm.

12. The bottom blowing furnace equipment according to claim 8, wherein the frequency converter further comprises a control switch configured to switch between the city power grid and the battery.

13. The bottom blowing furnace equipment according to claim 12, wherein the control switch comprises a hand control switch.

14. The bottom blowing furnace equipment according to claim 12, wherein the control switch comprises a contactor controlled by the controller.
